(19) United States
(12) Patent Application Publication
(10) Pub. No.: US 2026/0299270 A1
(43) Pub. Date: Oct. 1, 2026

(54) CONTROLLER FOR A SURGICAL MICROSCOPE AND METHOD

(71) Applicant: Leica Instruments (Singapore) Pte. Ltd., Singapore (SG)

(72) Inventor: George THEMELIS, Singapore (SG)

(21) Appl. No.: 18/880,570

(22) PCT Filed: Jul. 3, 2023
(86) PCT No.: PCT/IB2023/056886

§ 371 Date: Jan. 2, 2025

(30) Foreign Application Priority Data
Jul. 4, 2022 (DE) 10 2022 116 642.2

(51) Int. Cl. G02B 21/00; G01N 21/64; G02B 21/16

(52) U.S. Cl. CPC G02B 21/0012; G01N 21/64; G02B 21/16; G01N 2021/6421

(57) ABSTRACT

A controller for a surgical microscope can control an excitation unit to emit excitation light for exciting fluorophores located in a target area of a patient, control an optical detection unit to receive light from the target area and separate the light into a first and a second spectral channels, generate an image of the target area, determine a first intensity for each pixel of the image based on the first spectral channel and a second intensity for each pixel based on the second spectral channel, and determine a first image region and a second image region based on the first intensities and the second intensities. The first image region corresponds to a first region of the target area exhibiting fluorescence caused by the excited fluorophores. The second image region corresponds to a second region exhibiting fluorescence caused by a fluorescence source other than the excited fluorophores.

### CROSS REFERENCE TO RELATED APPLICATIONS

This application is a U.S. National Phase application under 35 U.S.C. § 371 of International Application No. PCT/IB2023/056886, filed on Jul. 3, 2023, and claims benefit to German Patent Application No. DE 10 2022 116 642.2, filed on Jul. 4, 2022. The International Application was published in English on Jan. 11, 2024 as WO 2024/009204 A1 under PCT Article 21(2).

### FIELD

Embodiments of the present invention relate to a controller for a surgical microscope and to a surgical microscope. Embodiments of the present invention further relate to a method for obtaining an image with a surgical microscope.

### BACKGROUND

In microsurgery, i.e. surgery aided by a surgical microscope, fluorescence imaging becomes increasingly more important. Fluorophores are introduced into a patient's body to mark specific substances and structures, such as blood vessels or cancer cells. The fluorophores are used to highlight substances and structures that would otherwise not or only hardly be visible to the unaided eye. For example, indocyanine green (ICG) binds to plasma proteins in blood and can be used to highlight blood vessels (angiography). Other fluorophores, e.g. aminolevulinic acid (5-ALA), bind to cancer cells, and can thus be used to highlight the position of cancerous tissue.

Typically, the fluorescence imaging is performed in a single narrow spectral band, e.g. in the near infrared region when using ICG as fluorophore, and produces a monochrome image. In the monochrome image it is impossible to distinguish diagnostic fluorescence signal, i.e. fluorescence signals originating from the used fluorophore, from unwanted fluorescence signals, i.e. signals from any other source, purely based on the fluorescence intensity.

Other applications exist within the context of microsurgery that utilize a broader spectral band for fluorescence imaging, such a 5-ALA fluorescence imaging. In these applications, a color image is produced and a surgeon can in theory distinguish diagnostic fluorescence signals from unwanted fluorescence signals by color. For example, in the case of 5-ALA fluorescence imaging the diagnostic fluorescence signal is pink, while e.g. bone fluorescence is white. Other objects may have virtually any color and may in particular exhibit the color of the diagnostic fluorescence signal. It is therefore not easy to distinguish diagnostic fluorescence signals from unwanted fluorescence signals, especially when the perceived color of the diagnostic fluorescence signal and the unwanted fluorescence signal are similar. In some cases, it is simply not possible to distinguish diagnostic from unwanted fluorescence, e.g. soft tissue autofluorescence appears of similar color as 5-ALA fluorescence, especially in weak fluorescence intensities. Even in the cases where it is possible to use the color information to distinguish diagnostic from unwanted fluorescence, this task is an additional burden for the surgeon.

Augmented Reality (AR) platforms that merge a fluorescence image with a reflectance or white light image of the operating theater typically display the fluorescence image in a single color. It is therefore not possible to distinguish diagnostic fluorescence signals from unwanted fluorescence signals with these platforms.

### SUMMARY

Embodiments of the present invention provide a controller for a surgical microscope. The controller is configured to control an excitation unit of the surgical microscope to emit excitation light for exciting fluorophores located in a target area of a patient, control an optical detection unit of the surgical microscope to receive light from the target area, and separate the received light into at least two spectral channels. A first spectral channel corresponding to a first wavelength band, and a second spectral channel corresponding to a second wavelength band. The controller is further configured to generate at least one image of the target area based on the received light. The image includes pixels. The controller is further configured to determine a first intensity for each pixel based on the first spectral channel, and a second intensity for each pixel based on the second spectral channel, and determine at least one first image region based on the first intensities and the second intensities. The first image region corresponds to a region of the target area exhibiting fluorescence caused by the excited fluorophores. The controller is further configured to determine at least one second image region based on the first intensities and the second intensities. The second image region corresponds to a region of the target area exhibiting fluorescence caused by a fluorescence source other than the excited fluorophores.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view of a surgical microscope according to an embodiment;

FIG. 2 is a flowchart of the method for obtaining an image of the target area with the surgical microscope according to some embodiments;

FIG. 3 shows three schematic diagrams, each showing the spectrum of a different component of the detection light, according to some embodiments; and

FIG. 4 is a schematic diagram of the spectra of the different component of the detection light illustrating the state of the art.

### DETAILED DESCRIPTION

Embodiments of the present invention provide a controller for a surgical microscope and a method for obtaining an image with a surgical microscope that allows a surgeon to easily distinguish diagnostic fluorescence signals from unwanted fluorescence signals.

According to some embodiments, a controller for a surgical microscope is configured to control an excitation unit of the surgical microscope to emit excitation light for exciting fluorophores located in a target area of a patient. The controller is configured to control an optical detection unit of the surgical microscope to receive light from the target area, and to separate the received light into at least two spectral channels. A first spectral channel corresponds to a first wavelength band, and a second spectral channel corresponds to a second wavelength band. The controller is configured to generate at least one image comprising pixels of the target area based on the received light, and to determine a first intensity for each pixel based on the first spectral channel and a second intensity for each pixel based on the second spectral channel. The controller is further configured to determine at least one first image region based on the first and second intensities, and at least one second image region based on the first and second intensities. The first image region corresponds to a region of the target area exhibiting fluorescence caused by the excited fluorophores. The second image region corresponds to a region of the target area exhibiting fluorescence caused by a fluorescence source other than the excited fluorophores.

The first and second regions may overlap. The overlap of the first and second regions corresponds to a region of the target area exhibiting fluorescence caused by the excited fluorophores as well as at least one fluorescence source other than the excited fluorophores. The first and second regions may be as small as a single pixel of the image of the target area. In particular, the controller may be configured to determine for each pixel whether the pixel corresponds to a region of the target area exhibiting fluorescence caused by the excited fluorophores, and/or whether the pixel corresponds to a region of the target area exhibiting fluorescence caused by a fluorescence source other than the excited fluorophores.

The received light is separated into at least two distinct spectral channels. This provides additional spectral information about the received light compared to using a single narrow spectral band. Different sources of fluorescence have different fluorescence spectra. For example, fluorescein has an emission maxima at 560 nm, 5-ALA has an emission maxima at 630 nm for 5-ALA, and ICG has an emission maxima at 830 nm. However, all fluorophores emit light at other wavelengths than their emission maxima. By comparing the intensities in the different spectral channels to the known spectrum of a particular fluorophore, the presence of that particular fluorophore can be determined. Likewise, other sources of fluorescence, e.g. autofluorescence of tissue or bone, have their own distinct spectral profiles, and can therefore be determined by comparing the intensities in the different spectral channels with the known spectral profile. Thus, the additional spectral information is used to distinguish between a diagnostic fluorescence signal and an unwanted fluorescence signal. The diagnostic fluorescence signal is the fluorescence caused by the excited fluorophores, e.g. the position of blood vessels indicated by the presence of ICG or the presence of cancerous tissue indicated by the presence of 5-ALA. The unwanted fluorescence signal fluorescence caused by a fluorescence source other than the excited fluorophores, e.g. autofluorescence of bone or tissue. By distinguishing between a diagnostic fluorescence signal and an unwanted fluorescence signal, additional mental load is taken of the surgeon, allowing them to perform their task more efficiently.

In a preferred embodiment, the controller is configured to determine the first and second image regions in real-time. Real time in the context of this document means in particular that no post-processing takes place. This allows the information about the first and second region, i.e. the position of blood vessels or cancerous tissue, to be passed to the surgeon without any noticeable delay. For example, the first and second regions may be presented to the surgeon as an overlay in an AR environment, thus expanding the surgeon's vision, thereby aiding the surgeon during microsurgery.

In another preferred embodiment, the controller is configured to determine the first and second image regions by spectral unmixing. Spectral unmixing refers to all methods that allow for the separation of different fluorescence sources based on the intensities detected in the different spectral channels. Spectral unmixing can be performed fast and reliable, allowing first and second image regions to be determined quickly. Methods for spectral unmixing include but are not limited to linear unmixing, principle component analysis, learning unsupervised means of spectra, support vector machines, neural networks, a (spectral) phasor approach, and Monte Carlo unmixing algorithms.

In another preferred embodiment, the controller is configured to control an illumination unit of the surgical microscope to emit illumination light for illuminating the target area, and to generate at least one reflectance image based on the received light. The reflectance image, also called white light image, shows the target area as the unaided human eye would see it. The reflectance image can be used to generate a composite image comprising reflectance image and the first and/or second image regions. Such a composite image can help the surgeon determine the position of the first and/or second image regions in the target area.

In another preferred embodiment, the controller is configured to control the optical detection unit to separate the received light into at least three spectral channels. A third spectral channel corresponds to a third wavelength band. The third wavelength band is complementary to the first and second wavelength bands. The controller is further configured to generate the reflectance image based on at least the third spectral channel. This allows the first and second wavelength bands to be processed separately from the reflectance image. For example, the first and second spectral channels may be enhanced or reduced in intensity before they are displayed to the surgeons. In this embodiment, the third wavelength band is complementary to the first and second wavelength band, i.e. the third wavelength band and the first and second wavelength bands are non-overlapping. In particular, the third wavelength band may encompass all optical wavelengths except for the first and second wavelength bands. In such an embodiment, the reflectance image would not display first and second wavelength bands.

In another preferred embodiment, the controller is configured to determine the first and second image regions based on the reflectance image. In this embodiment, additional information in the form of the reflectance image is used to determine the first and second image regions. For example, the controller may be configured to detect a non-biological object, e.g. a glove or a surgical instrument, in the reflectance light image of the target area using image detection, and to determine that any fluorescence light emitted by the glove cannot be the diagnostic fluorescence signal. Using the additional information in form of the reflectance image enhances the reliability with which the controller can determine the first and second image regions.

In another preferred embodiment, the controller is configured to determine the first and second image regions using machine learning. In this embodiment, the controller uses machine learning to distinguish the diagnostic fluorescence signal and an unwanted fluorescence signal. In particular, additional information such as the reflectance image of the target area is used to determine the first and second image regions using machine learning. For example, the controller may be configured to perform image detection facilitated by machine learning in order to detect the non-biological object. In other words, the controller may be configured to perform a sematic segmentation of the image of the target area using machine learning. For example, certain areas may be determined to be a non-biological object, e.g. a glove or a surgical instrument. The result of the image segmentation may then be used to exclude certain regions of the image of the target area to be emitters of the diagnostic fluorescence signal, e.g. the aforementioned non-biological object. Thus, the use of machine learning can greatly aid the determination of the diagnostic fluorescence signal and thereby improve the reliability of the controller.

Machine learning techniques include but are not limited to support vector machines and neural networks. Most machine learning techniques require either supervised or unsupervised training using an appropriate training dataset. The choice of the training dataset depends on the specific task of the machine learning technique used. In the above example of detecting a non-biological object in the image of the target area, the appropriate training dataset would consist of images, in particular images captured by means of a surgical microscope, of various foreign objects inside a patient's body.

In another preferred embodiment, the controller is configured to generate a composite image from the first image region and the image of the target area, and to control an output unit of the surgical microscope to display the image of the target area and/or the composite image. The composite image aids the surgeon in determining the position of the first and/or second image regions in the target area, thereby reducing mental load during microsurgery and allowing the surgeons to perform their task more efficiently. In the composite image, the first and second regions are preferably highlighted such that they are easily identified.

In another preferred embodiment, the controller is configured to generate the composite image from the first image region, the second image region, and the image of the target area. The first image region has a first color, and the second image region has a second color. The second color is different from first color. Displaying the different regions in different colors helps the surgeon to differentiate between the diagnostic fluorescence signal and the unwanted fluorescence signal. Displaying the second image region, i.e. the region emitting what the controller has determined to be an unwanted fluorescence signal, further allows the surgeon to verify the determination by the controller, thereby giving the surgeon all the information to make informed decisions during microsurgery.

In another preferred embodiment, the controller is configured to generate the composite image from the first image region, the second image region, and the image of the target area. The first image region or the second image region is a blinking overlay over the image of the target area. Displaying the second region as a blinking overlay helps the surgeon to differentiate between the diagnostic fluorescence signal and the unwanted fluorescence signal. In particular this allows the surgeon to verify the determination by the controller during microsurgery.

In another preferred embodiment, the first and second wavelength bands do not overlap. In this embodiment, the first and second wavelength bands complement each other allowing a more reliable determination of the first and second image regions.

Embodiments of the invention also relate to a surgical microscope comprising a controller as described above, an excitation unit configured to emit excitation light for exciting fluorophores located in a target area of a patient, and an optical detection unit configured to receive light from the target area, and to separate the received light into at least two spectral channels. A first spectral channel corresponds to the first wavelength band, and a second spectral channel corresponds to the second wavelength band.

The surgical microscope comprises the controller described above, and therefore has the same advantages as the controller.

In a preferred embodiment, the surgical microscope further comprises an illumination unit configured to emit illumination light for illuminating the target area. The illumination unit can in particular be used in generating the reflectance image.

In another preferred embodiment, the surgical microscope comprises an output unit. In particular, the output unit is one of a screen, an eye piece, an augmented-reality set and a virtual-reality set. The output unit may be configured to display the image of the target area and/or the composite image.

In another preferred embodiment, the optical detection unit comprises at least one microscope objective that is directed at the target area, and configured to receive the light from the target area. A microscope objective may provide magnification allowing the surgeon to see small details of the target area than would be visible to the unaided eye. In other words, magnification allows the surgeon to perform microsurgery, e.g. surgery of small blood vessels or nerves with a diameter of 1 mm or less.

In another preferred embodiment, the optical detection unit comprises at least two detector elements and beam splitting means that are configured to direct received light having a wavelength in the first wavelength band onto a first detector element, and to direct received light having a wavelength in the second wavelength band onto a second detector element. In this embodiment, the beam splitting element and the first and second detector elements are used as means for generating the first and second spectral channels. Compared to other means for generating the first and second spectral channels using the beam splitting element and the first and second detector elements is easy to implement, cost-effective, and reliable.

In another preferred embodiment, the optical detection unit is configured to separate the received light into at least three spectral channels. A third spectral channel corresponds to a third wavelength band. In particular, the third wavelength band is complementary to the first and second wavelength bands. An optical arrangement that separates the received light into three complementary wavelength bands can easily be realized by means of beams splitters. Such an optical arrangement has the advantage that the received light is distributed among the detector elements, and thus little to no received light is lost as would for example be the case with a multispectral camera.

In another preferred embodiment, the optical detection unit comprises a multispectral camera or a hyper spectral camera configured to generate the first and second spectral channels. A multispectral camera is configured to capture a limited number of wavelength bands, typically less than or around 10. Each of these wavelength bands maybe a spectral channel of the surgical microscope. A hyperspectral camera is configured to capture tens or hundreds of wavelength bands per pixel. In other words, hyperspectral images have a very high spectral resolution. More spectral channels allow for a much finer differentiation of sources of fluorescence in the image of the target area based on their emission spectrum and thereby increases the sensitivity and reliability of the surgical microscope.

Embodiments of the invention further relate to a method for obtaining an image with a surgical microscope, comprising the following steps: Exciting fluorophores in a target area of a patient. Receiving light from the target area. Separating the received light into at least two spectral channels, a first spectral channel corresponding to a first wavelength band, and a second spectral channel corresponding to a second wavelength band. Generating at least one image of the target area based on the received light, the image comprising pixels. Determining a first intensity for each pixel based on the first spectral channel, and a second intensity for each pixel based on the second spectral channel. Determining at least one first image region based on the first and second intensities, the first image region corresponding to a region of the target area exhibiting fluorescence caused by the excited fluorophores. Determining at least one second image region based on the first and second intensities, the second image region corresponding to a region of the target area exhibiting fluorescence caused by a fluorescence source other than the excited fluorophores.

The method has the same advantages as the controller described above and can be supplemented using the features of the dependent claims directed at the controller.

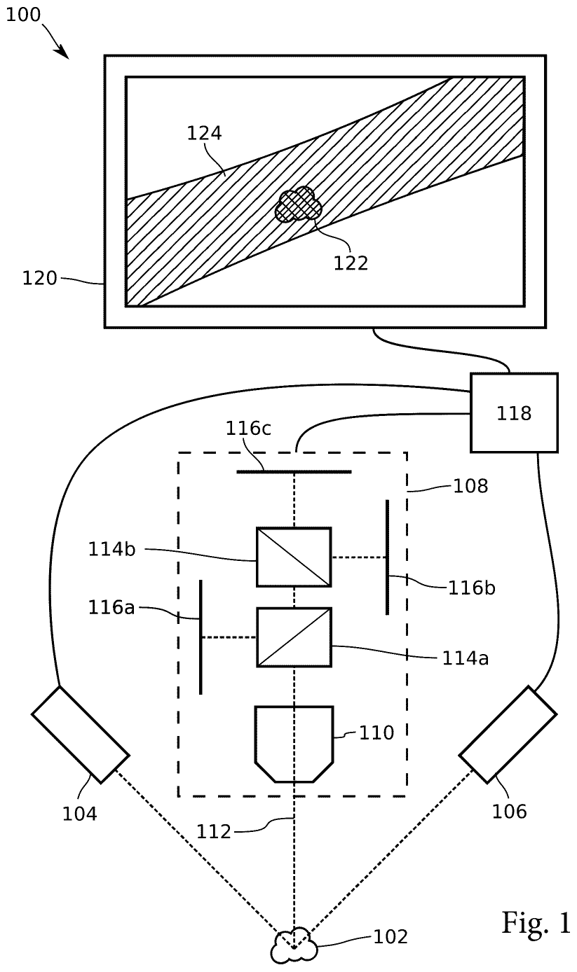

FIG. 1 is a schematic view of a surgical microscope 100 according to an embodiment.

The surgical microscope 100 is adapted to provide a surgeon with a magnified image of a target area 102 inside a patient's body, e.g. during microsurgery. In particular, the surgical microscope 100 is adapted to obtain a fluorescence image of the target area 102. That is an image generated from fluorescence light emitted by fluorophores located in the target area 102.

An illumination unit 104 of the surgical microscope 100 is directed at the target area 102 and configured to illuminate the target area 102 using white light. An excitation unit 106 of the surgical microscope 100 is configured to emit excitation light towards the target area 102 for exciting the fluorophores. The excitation unit 106 may in particular comprise a source of coherent light, e.g. a white light laser, a continuous wave laser or a pulsed laser having a single emission wavelength.

An optical detection unit 108 of the surgical microscope 100 has at least one microscope objective 110 directed at the target area 102 and configured to receive detection light 112 from the target area 102. The detection light 112 comprises multiple components. Among the components of the detection light 112 are fluorescence light emitted by the excited fluorophores, fluorescence light emitted by sources other than the excited fluorophores, and reflectance light caused by the white light illumination. The fluorescence light emitted by the excited fluorophores is a wanted or diagnostic fluorescence signal while the fluorescence light emitted by other sources is an unwanted fluorescence signal.

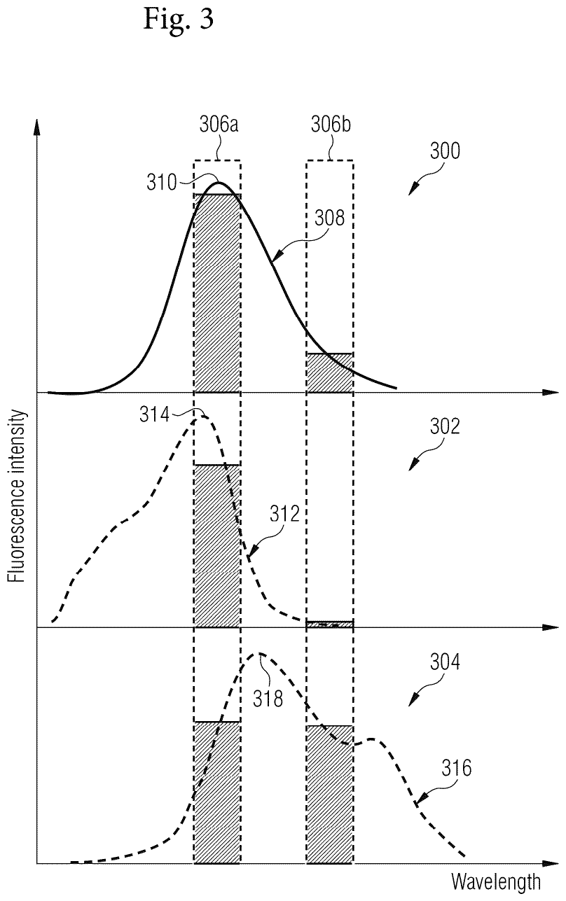

The optical detection unit 108 is exemplary configured to generate three spectral channels, i.e. to separately detect detection light 112 in a first, a second, and a third wavelength band. The three wavelength bands are described below with reference to FIG. 3 in more detail. In order to generate the three spectral channels, the optical detection unit 108 exemplary comprises an arrangement of beam splitting elements 114a, 114b, e.g. dichroic elements or an acousto optic tunable filter (AOTF), and detector elements 116a, 116b, 116c. Alternatively, the three spectral channels maybe generated by other means, e.g. a multispectral or hyperspectral camera.

A first beam splitting element 114a is arranged in the beam path of the detection light 112 following the microscope objective 110. The first beam splitting element 114a is configured to direct detection light 112 of the first wavelength band onto a first detector element 116a. The remaining detection light 112 is directed at a second beam splitting element 114b. The second beam splitting element 114b is configured to direct detection light 112 of the second wavelength band onto a second detector element 116b. The then remaining detection light 112 is directed at a third detector element 116c.

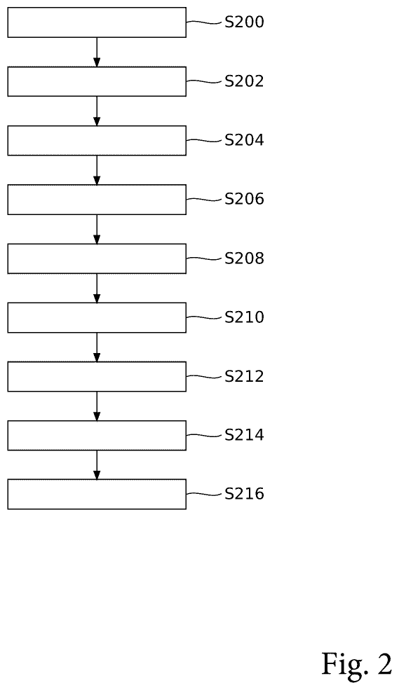

The surgical microscope 100 further comprises a controller 118. The controller 118 is connected to the illumination unit 104, the excitation unit 106, the optical detection unit 108, and an output unit 120. The controller 118 configured to control said elements of the surgical microscope 100. In particular, the controller 118 is configured to perform a method for obtaining an image of the target area 102 that is described below with reference to FIG. 2.

The image or images of the target area 102 generated by the controller 118 are displayed to the surgeon by the output unit 120 of the surgical microscope 100. In this embodiment, the output unit 120 is exemplary shown to be a monitor. In FIG. 1 the output unit 120 exemplary shows a composite image of the target area 102 comprising a reflectance or white light image of the target area 102, a first image region 122 and a second image region 124. The first image region 122 corresponds to a diagnostic fluorescence signal, in this example a tumor marked by 5-ALA. The second region corresponds to an unwanted fluorescence signal, in this example bone autofluorescence. In FIG. 1, the first and second image regions 122, 124 are distinguished by a different hatching. In an actual embodiment the first and second image regions 122, 124 may be distinguished by a different color. Alternatively, the first image region 122 or the second image region 124 may be displayed as a blinking overlay over the reflectance image.

FIG. 2 is a flowchart of the method for obtaining an image of the target area 102 with the surgical microscope 100 described above.

The process is started in step S200. In step S202 the controller 118 controls the excitation unit 106 to emit excitation light towards the target area 102 in order to excite the fluorophores located in the target area 102. In step 204 the controller 118 controls the optical detection unit 108 to receive light from the target area 102. The received light is split into at least two, in the present embodiment three spectral channels. In the present embodiment, the first spectral channel is generated by the first detector element and corresponds to the first wavelength band, the second spectral channel is generated by the second detector element and corresponds to the second wavelength band, and the third spectral channel is generated by the third detector element and corresponds to the third wavelength band.

In step S206 the controller 118 generates at least one image of the target area 102 based on the received light, i.e. the detection light, the image comprising pixels. In step S208 the controller 118 determines a first intensity for each pixel based on the first spectral channel, and a second intensity for each pixel based on the second spectral channel. In the present embodiment, the controller 118 generates a first image corresponding to the detection light 112 received by the first detector element, and a second image corresponding to the detection light 112 received by the second detector element. The first and second image are monochromatic images corresponding to the intensity of detection light 112 received in the first and second wavelength bands, respectively. That is, each pixel of the first and second images stores information about the intensity of light received in the first and second wavelength bands, respectively. Further, in this embodiment, the controller 118 generates a third image of the target area 102 based on the light received in the third wavelength band. The third image may in particular be a color image of the target area 102. That is, the third image is a reflectance image. Alternatively, the controller 118 may generate a single image of the target area 102. In this alternative embodiment, each pixel of the single image comprises information about the intensity of light received in the three detection channels.

In step S210 the controller 118 determines the first image region 122 based on the first and second intensities, and in step S212 the controller 118 determines the second image region 124 based on the first and second intensities. The determination of the first and second image regions 122, 124 is described in more detail below with reference to FIG. 3.

In step S214 the controller 118 generates the image of the target area 102 based on the first and second image regions 122, 124, and controls the output unit 120 to output the image of the target area 102 to the surgeon. In case the output unit 120 is a monitor, a digital eyepiece or the like, the controller 118 may generate a composite image comprising the reflectance image of the target area 102, and the first and second image regions 122, 124. In case the output unit 120 is an AR set or the like, the controller 118 may generate a composite image comprising the first and second image regions 122, 124 that can be displayed to the surgeon as an AR overlay. In step S216 the process is ended.

FIG. 3 shows three schematic diagrams 300, 302, 304, each showing the spectrum of a different component of the detection light 112.

The abscissa of each diagram 300, 302, 304 denotes wavelength. The ordinate of each diagram 300, 302, 304 denotes intensity. The first and second wavelength bands are indicated in the diagrams 300, 302, 304 by dashed rectangles 306a, 306b.

A first diagram 300 shows the spectrum 308 of the fluorescence light emitted by the fluorophores, i.e. the spectrum of the diagnostic fluorescence signal. The diagnostic fluorescence signal has it maximum 310 in the first wavelength band. The intensity of the diagnostic fluorescence signal in the second wavelength band is about a fifth of the diagnostic fluorescence signal at its maximum.

A second diagram 302 shows the spectrum 312 of autofluorescence light emitted by a first tissue, i.e. the spectrum of a first unwanted fluorescence signal. The first unwanted fluorescence signal has it maximum 314 in the first wavelength band. The intensity of the first unwanted fluorescence signal in the second wavelength band is almost zero.

A third diagram 304 shows the spectrum 316 of autofluorescence light emitted by a second tissue, i.e. the spectrum of a second unwanted fluorescence signal. The second unwanted fluorescence signal has it maximum 318 between the first wavelength band and the second wavelength band. The intensity of the second unwanted fluorescence signal in the first wavelength band and in the second wavelength band is about equal.

As can be seen from the three diagrams 300, 302, 304, each source of fluorescence light has its characteristic spectrum 308, 312, 316 that can be determined by the intensities detected in the first and second wavelength bands, i.e. the first and second detection channels. It is therefore possible to determine for each pixel the source of the fluorescence light received based on the first and second detection channels.

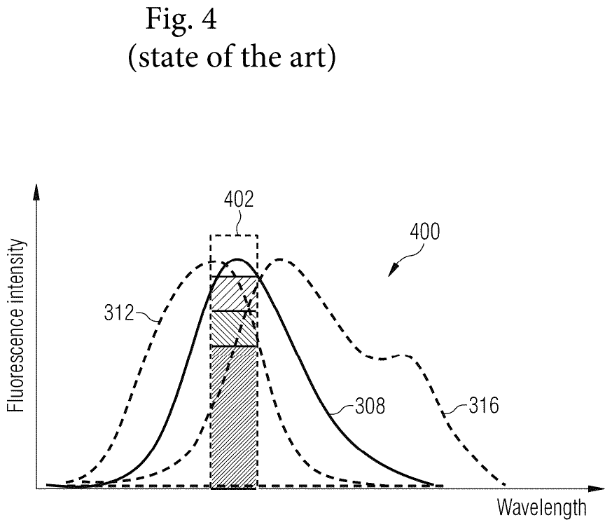

FIG. 4 is a schematic diagram of the spectra of the different component of the detection light 112.

FIG. 4 illustrates the state of the art in which only a single narrow wavelength band is used to capture the diagnostic fluorescence signal. The abscissa of the diagram 400 denotes wavelength. The ordinate of the diagram 400 denotes intensity. The single narrow wavelength band is indicated in the diagram 400 by a dashed rectangles 402.

In FIG. 4 the spectrum 308 of the diagnostic fluorescence signal is shown as a solid curve. The spectra 312, 316 of the two unwanted fluorescence signals are shown as dashed lines. As can be seen, the three sources of fluorescence light are distinguished by their intensity in the single narrow wavelength band. However, since it is not easily possible to normalize the three signals, it is not possible to distinguish the signals by their intensity in the single narrow wavelength band alone.

Identical or similarly acting elements are designated with the same reference signs in all Figures. As used herein the term “and/or” includes any and all combinations of one or more of the associated listed items and may be abbreviated as “/”. Individual features of the embodiments and all combinations of individual features of the embodiments among each other as well as in combination with individual features or feature groups of the preceding description and/or claims are considered disclosed.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 surgical microscope
102 target area
104 illumination unit
106 excitation unit
108 optical detection unit
110 objective
112 detection light
114a, 114b beam splitting element
116a, 116b, 116c detector element
118 controller
120 output unit
122, 124 image region
300, 302, 304 diagram
306a, 306b rectangle
308 spectrum
310 maximum
312 spectrum
314 maximum
316 spectrum
318 maximum
400 diagram
402 rectangle

1: A controller for a surgical microscope, the controller configured to:
control an excitation unit of the surgical microscope to emit excitation light for exciting fluorophores located in a target area of a patient;
control an optical detection unit of the surgical microscope to receive light from the target area, and separate the received light into at least two spectral channels, a first spectral channel corresponding to a first wavelength band, and a second spectral channel corresponding to a second wavelength band;
generate at least one image of the target area based on the received light, the image comprising pixels;
determine a first intensity for each pixel based on the first spectral channel, and a second intensity for each pixel based on the second spectral channel;
determine at least one first image region based on the first intensities and the second intensities, the first image region corresponding to a region of the target area exhibiting fluorescence caused by the excited fluorophores; and
determine at least one second image region based on the first intensities and the second intensities, the second image region corresponding to a region of the target area exhibiting fluorescence caused by a fluorescence source other than the excited fluorophores.

2: The controller according to claim 1, configured to determine the first image region and the second image region in real-time.

3: The controller according to claim 1, configured to determine the first image region and the second image region by spectral unmixing.

4: The controller according to claim 1, further configured to control an illumination unit of the surgical microscope to emit illumination light for illuminating the target area and to generate at least one reflectance image based on the received light.

5: The controller according to claim 4, configured to control the optical detection unit to separate the received light into at least three spectral channels; wherein a third spectral channel corresponds to a third wavelength band; wherein the third wavelength band is complementary to the first and second wavelength bands; and wherein the controller is configured to generate the reflectance image based on at least the third spectral channel.

6: The controller according to claim 4, configured to determine the first image region and the second image region based on the reflectance image.

7: The controller according to claim 1, configured to determine the first image region and the second image region using machine learning.

8: The controller according to claim 1, further configured to generate a composite image from the first image region and the image of the target area and to control an output unit of the surgical microscope to display the image of the target area and/or the composite image.

9: The controller according to claim 8, configured to generate the composite image from the first image region, the second image region, and the image of the target area; wherein the first image region has a first color, and the second image region has a second color, the second color being different from first color.

10: The controller according to claim 8, configured to generate the composite image from the first image region, the second image region, and the image of the target area; wherein the first image region or the second image region is a blinking overlay over the image of the target area.

11: The controller according to claim 1, wherein the first and second wavelength bands do not overlap.

12: A surgical microscope comprising
a controller according to claim 1,
the excitation unit configured to emit the excitation light for exciting the fluorophores located in the target area of the patient, and
the optical detection unit configured to receive the light from the target area, and to separate the received light into the at least two spectral channels, the first spectral channel corresponding to the first wavelength band, and the second spectral channel corresponding to the second wavelength band.

13: The surgical microscope according to claim 12, comprising an output unit.

14: The surgical microscope according to claim 12, wherein the optical detection unit comprises at least one microscope objective that is directed at the target area, and configured to receive the light from the target area.

15: The surgical microscope according to claim 12, wherein the optical detection unit comprises at least two detector elements and a beam splitter configured to direct the received light having a wavelength in the first wavelength band onto a first detector element, and to direct received light having a wavelength in the second wavelength band onto a second detector element.

16: The surgical microscope according to claim 12, wherein the optical detection unit comprises a multispectral camera or a hyper spectral camera configured to generate the first spectral channel and the second spectral channel.

17: A method for obtaining an image with a surgical microscope, the method comprising:
exciting fluorophores in a target area of a patient;
receiving light from the target area;
separating the received light into at least two spectral channels, a first spectral channel corresponding to a first wavelength band, and a second spectral channel corresponding to a second wavelength band;
generating at least one image of the target area based on the received light, the image comprising pixels;
determining a first intensity for each pixel based on the first spectral channel, and a second intensity for each pixel based on the second spectral channel;
determining at least one first image region based on the first intensities and the second intensities, the first image region corresponding to a region of the target area exhibiting fluorescence caused by the excited fluorophores; and
determining at least one second image region based on the first intensities and the second intensities, the second image region corresponding to a region of the target area exhibiting fluorescence caused by a fluorescence source other than the excited fluorophores.
